(19) United States
(12) Patent Application Publication
(10) Pub. No.: US 2018/0060452 A1
(43) Pub. Date: Mar. 1, 2018

(54) System and Method for Generating System Testing Data

(71) Applicant: CA, Inc., New York, NY (US)

(72) Inventors: Alex Esterkin, Revere, MA (US); David Rich, Ayer, MA (US); James Mercer, Millville, MA (US)

(73) Assignee: CA, Inc., New York, NY (US)

(21) Appl. No.: 15/244,567

(22) Filed: Aug. 23, 2016

(51) Int. Cl. G06F 17/50

(52) U.S. Cl. CPC G06F 17/5009

(57) ABSTRACT

A method includes providing a hierarchy of pattern definitions, wherein each pattern definition in the hierarchy of pattern definitions is associated with a parameter that is used to simulate operation of a computer system, and wherein each pattern definition in the hierarchy of pattern definitions comprises at least a value producer and a time interval, and traversing the hierarchy of pattern definitions for each parameter to select a pattern definition. The method further includes generating an event associated with the parameter in accordance with the value generator of the selected pattern definition, and transmitting the event to a system testing platform.

### BACKGROUND

Various embodiments described herein relate to computer software, and in particular to systems and methods for generating simulation data for predicting system performance and capacity of computing systems.

Information technology (IT) systems include a large number of components, such as servers, storage devices, routers, gateways, and other equipment. When an IT system is designed, an architecture is specified to meet various functional requirements, such as capacity, throughput, availability, and redundancy. In order to determine if a proposed system architecture can meet the functional performance requirements, it is desirable to simulate operation of the system before it is built, as building and testing an IT system before deployment may be cost prohibitive, particularly if a production-like test environment is built. This process is sometimes referred to as performance modeling, which refers to creating a computer model that emulates the performance of a computer system.

Performance modeling may be used to test the performance of an IT system before it is built. In general, capacity management requires predicting future needs based on historical results. This approach requires having performance data for the system available in order to calibrate the model. The accuracy of the modeling results depends on the availability of reliable and plausible simulation data.

Performance modeling can also be used as part of capacity planning to plan for future growth of current systems. Today most data centers are under-utilized, and server over-provisioning is often used an expensive means to ensure fulfillment of service level agreements (SLAs) in order to keep up with increasing business demands for faster delivery of IT services. Data center growth can cause significant strain on IT budgets and management overhead. IT organizations bear the capital expenditure and operating costs of this equipment and are looking for safe, predictable and cost-effective ways to consolidate and optimize their data center infrastructure. Many organizations have turned to virtualization to consolidate servers and reclaim precious data center space in hope to realize higher utilization rates and increased operational efficiency. Without proper tools and processes, IT organizations are experiencing “VM sprawl,” increasing software license costs and complexity.

As those skilled in the art will appreciate, performance modeling can be used to predict and analyze the effect of various factors on the modeled system. These factors include changes to the input load, or to the configuration of hardware and/or software. Indeed, performance modeling has many benefits, including performance debugging (identifying which, if any, system components are performing at unacceptable levels, and why they are underperforming), capacity planning (applying projected loads to the model to analyze what hardware or configurations would be needed to support the projected load), prospective analysis (the ability to test “what if” scenarios with respect to the system, its configuration, and its workload), and system “health” monitoring (determining whether the computer system is operating according to expected behaviors and levels).

While performance modeling provides tremendous benefits, currently, good performance modeling is difficult to obtain. More particularly, it is very difficult to accurately and adequately create a performance model for a typical system in all its complexity. As such, generating performance models have largely been the purview of consultants and others with specialized expertise in this arena. Even more, performance modeling is currently the product of laboratory, controlled environment analysis. As such, even the best performance models only approximate what actually occurs in the “live,” deployed and operating system.

### SUMMARY

A method according to some embodiments includes providing a hierarchy of pattern definitions, wherein each pattern definition in the hierarchy of pattern definitions is associated with a parameter that is used to simulate operation of a computer system, and wherein each pattern definition in the hierarchy of pattern definitions comprises at least a value producer and a time interval, and traversing the hierarchy of pattern definitions for each parameter. Traversing the hierarchy of pattern definitions includes repeating, until a final pattern definition is selected, steps of: (a) retrieving a first pattern definition, (b) determining if a simulation time falls within the time interval associated with the first pattern definition, (c) in response to determining that the simulation time falls within the time interval associated with the first pattern definition, determining if the first pattern definition is overridden by a subsequent pattern definition in the hierarchy of pattern definitions, (d) in response to determining that the first pattern definition is overridden by a subsequent pattern definition, retrieving the subsequent pattern definition, and (e) in response to determining that the first pattern definition is not overridden by a subsequent pattern definition, selecting the first pattern definition as the final pattern definition. The method further includes generating an event associated with the parameter in accordance with the value generator of the selected pattern definition, and transmitting the event to a system testing platform.

The method may further include sequentially selecting a system element from a plurality of system elements in the computer system, and generating events related to the selected system element.

The method may further include generating a plurality of events associated with the parameter in accordance with the value generator, and transmitting the plurality of events to the system testing platform.

The hierarchy of pattern definitions for a given parameter may include a list of pattern definitions arranged in hierarchical order, and wherein traversing the hierarchy of pattern definitions comprises processing the list sequentially until a pattern definition is found that is not overridden by a subsequent pattern definition.

The value producer may define a type of value produced and a range of value produced. In particular embodiments, the value producer may include one of a linear deterministic value producer and a nonlinear deterministic value producer. The value producer may include a random value producer.

The value producer may include a random value producer and a deterministic value producer, wherein the value is produced as a sum of the output of the random value producer and the deterministic value producer.

Related systems and computer program products are provided.

It is noted that aspects described herein with respect to one embodiment may be incorporated in different embodiments although not specifically described relative thereto. That is, all embodiments and/or features of any embodiments can be combined in any way and/or combination. Moreover, other systems, methods, and/or computer program products according to embodiments will be or become apparent to one with skill in the art upon review of the following drawings and detailed description. It is intended that all such additional systems, methods, and/or computer program products be included within this description, be within the scope of the present disclosure, and be protected by the accompanying claims.

### BRIEF DESCRIPTION OF THE DRAWINGS

Aspects described herein are illustrated by way of example and are not limited by the accompanying figures, with like references indicating like elements.

FIG. 1 is a block diagram that illustrates a performance modeling system according to various embodiments described herein.

FIG. 2 is a block diagram that illustrates relationships between parameters and parameter definitions according to various embodiments described herein.

FIG. 3 is a graph illustrating data generated in accordance with various embodiments described herein.

FIGS. 4 and 5 are flowcharts of operations that may be performed according to various embodiments described herein.

FIG. 6 is a graph illustrating data generated in accordance with various embodiments described herein.

FIG. 7 is a block diagram of an event generator that is configured according to various embodiments described herein.

FIG. 8 is a block diagram of a performance modeling system that is configured according to various embodiments described herein.

### DETAILED DESCRIPTION

Some embodiments of the inventive concepts provide systems and methods that generate simulation data for testing IT system architectures in the design, planning or production phase. Testing the quality of predicted performance requires a flexible tool that can produce controlled data. Moreover, testing features such as business hours requires the ability to generate sophisticated data patterns. Accordingly, to generate simulated data, such as network traffic levels, processor utilization, etc., for an IT system, it is desirable to have a tool that generates realistic and controlled data.

Some embodiments described herein provide a flexible method for generating time series data based on hierarchical rule based configuration with pluggable value producers. In particular, various embodiments described herein provide a method and a tool for generating time series data that can be used for testing an IT system.

Various embodiments employ a hierarchical rule configuration with pluggable value producers. The value producers may have a configurable randomization level that provides a way to define sophisticated data patterns.

The embodiments described herein can make the process of performance modeling faster and/or more efficient by providing ways to model very complicated dependencies quickly and with minimal configuration.

Capacity manager testing requires months of metric data. Collecting real time data can take a prohibitively long time, and the data collected real time is often unpredictable and uncontrolled. Moreover, real time data may not be appropriate for stressing an IT system model in ways that system planners would like to see the system stressed. For example, real time data that reflects ordinary system loading may not stress the IT system in a way that adequately reveals the system's ability to deal with extraordinary system loading.

In general, when generating metric data for use in performance modeling, it is extremely useful to be able to generate metrics with an arbitrary level of daily and hourly behavior, as it is desirable to be able to test the system against a variety of time series data patterns.

A capacity management product, such as CA Capacity Manager by Computer Associates, Inc., Islandia, N.Y., predicts future needs based on historical results. Testing the quality of predictions requires a flexible tool that can produce controlled data. Moreover, the testing of features that depend on business hours requires the ability to generate sophisticated data patterns. For demonstration and/or planning purposes, it is desirable to have a tool that can feed the capacity management product with realistic and controlled data that can help highlight various product features.

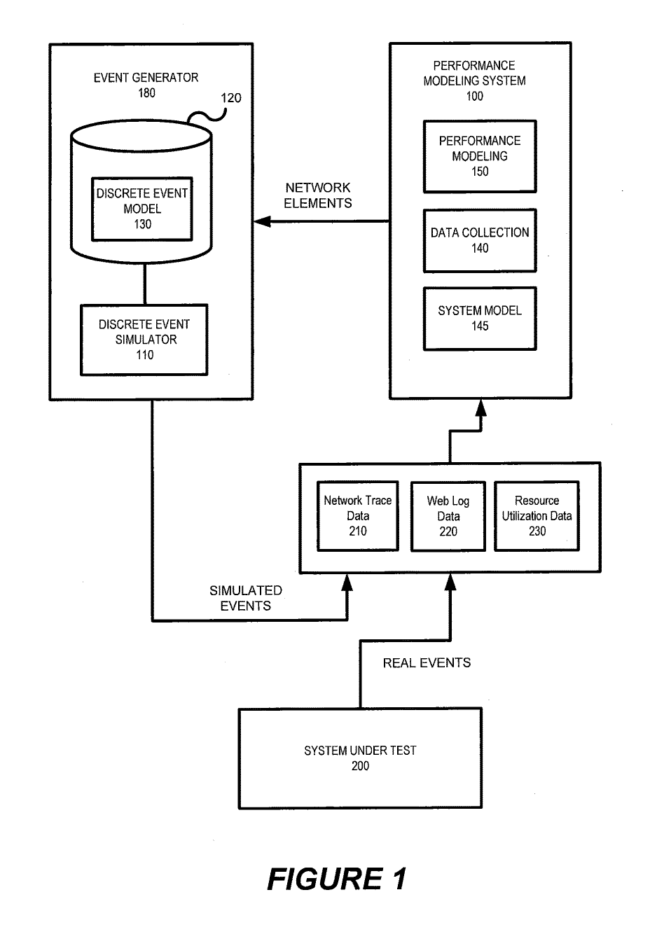

FIG. 1 is a block diagram that illustrates an event generator 180 according to various embodiments described herein. The event generator 180 generates simulated events, such as simulated metric data, that can be processed by a performance modeling system 100. The performance modeling system 100 can also receive real events from a system under test 200. The simulated events generated by the event generator 180 can supplement or replace real events generated by the system under test 200. Both or either of the simulated events or the real events can be used by the performance modeling system to model the system under test or a different system.

The events generated by the event generator 180 or derived from the system under test 200 may include, for example, network trace data 210, web log data 220 and/or resource utilization data 230, such as CPU usage, memory usage, throughput, communication link bandwidth usage, etc.

The event generator 180 includes a database 120 that stores at least one discrete event model 130 that is used to generate simulation data according to various embodiments described herein. The event generator 180 further includes a discrete event simulator 110 that generates the generate simulation data according to various embodiments described herein by processing and applying the discrete event model 130.

The performance modeling system 100 may include at least a data collection module 140 that collects event data from the event generator 180 and/or a system under test 200, and a performance modeling module 150 that applies the event data to a system model 145 stored or accessible by the performance modeling system 100. The performance modeling system 100 may provide network element information to the event generator 180. In response, the event generator 180 may generate simulation data in the form of simulated events for the identified network elements and transmit the simulated events back to the performance modeling system 100.

There may be a number of parameters associated with each network element. For each network element, the event generator may generate events associated with each parameter of the network element. Thus, in order to generate simulation data for an IT system, the event generator 180 may generate a series of simulated events for each parameter of each network element in the system.

The parameters for various types of network elements may differ based on the type of network element in question. For example, a processor may have as its parameters CPU utilization, cache utilization, thread usage, etc.

According to some embodiments, a metric configuration is provided for each parameter which includes a nested set of pattern definitions (rules). For each parameter, the configurational hierarchy is processed top to bottom with the next rule overwriting the previous rule for the time period where the rules overlap.

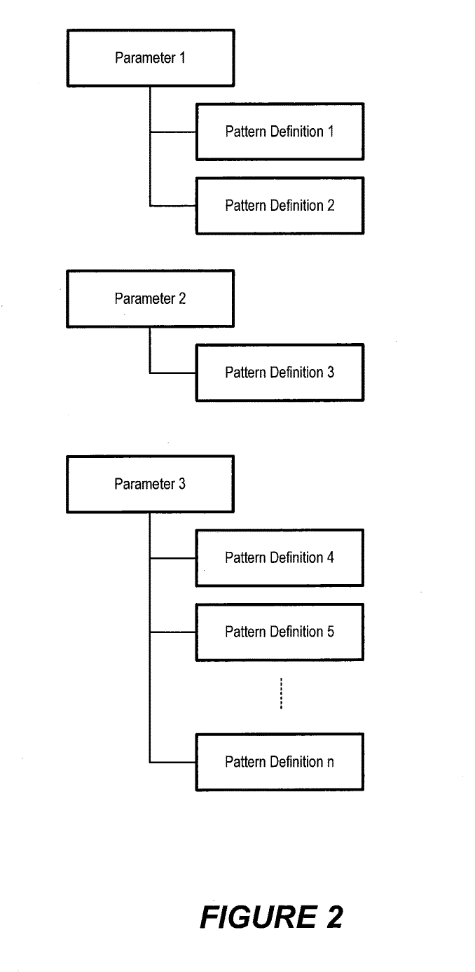

FIG. 2 illustrates a plurality of parameters associated with a network element. Each of the parameters has an associated set of pattern definitions arranged in hierarchical order. For example, Parameter 1 is associated with Pattern Definition 1 and Pattern Definition 2. Parameter 2 is associated with Pattern Definition 3. Parameter 3 is associated with Pattern Definitions 1 to n.

Each pattern definition is a rule that supports a value producer and defines logical expressions describing the time period during which the rule should be applied. While multiple value producers can be implemented within the tool (e.g., Linear, Random, Sine, ArcTan) the tool also provides an open architecture to which custom value producers can be added.

In some embodiments, the value producer may include one of a linear deterministic value producer and a nonlinear deterministic value producer. The value producer may include a random value producer.

In some embodiments, the value producer may include both a random value producer and a deterministic value producer, wherein the value is produced as a sum of the output of the random value producer and the deterministic value producer.

A pattern definition may be stated, for example, in XML (extensible markup language) for ease of application. However, the inventive concepts are not limited thereto, and other formats, such as key/value files, can be used to arrange the pattern definitions.

Each pattern definition may include, for example, the fields shown in Table 1, below:

TABLE 1
Pattern Definition Fields

| Field | Description |
|---|---|
| <day></day> | The day of the week for which the rule applies |
| <hour></hour> | The hours of the day for which the rule applies |
| <valuesperhour> | The number of simulation values produced per |
| </valuesperhour> | hour of simulated time |
| <valueproducer type> | The function used to produce the values. For |
| | example, the value producer could be linear, |
| | random, sinusoidal, exponential, etc. |
| | User-defined functions can also be used. |

The value producer field may have a number of sub-fields, such as those shown in Table 2, below.

TABLE 2
Value Producer Subfields

| Subfield | Description |
|---|---|
| <minvalue></minvalue> | A minimum value of the metric. |
| <maxvalue></maxvalue> | A maximum value of the metric. |
| <noisepercent></noisepercent> | An amount of noise added to each |
| | value. |
| <initvalue></initvalue> | An initial value of the metric. |
| <finalvalue></finalvalue> | A final value of the metric. |
| <initslope></initslope> | An initial slope of the value producer. |

Table 2 shows an example configuration file according to some embodiments that defines a metric, referred to as “Total CPU Utilization,” that specifies CPU utilization pattern with three rules. The first rule specifies that where CPU usage grows linearly 10 to 15 with a 10% randomness factor. The second rule specifies that every day between 6 pm and 9 pm the CPU usage value is random within 30-40 range. Thus, the second rule overrides the first rule every day between 6 PM and 9 PM. The third rule specifies that on Thursdays, the CPU usage equals 60 between 12 and 2 pm. The third rule overrides both the first and second rules on Thursdays between 12 PM and 2 PM.

TABLE 3
Total CPU Utilization Definition

<metric><metric name=″Total CPU Utilization″>
<rules>
<rule>
<day>*</day>
<hour>*</hour>
<valuesperhour>2</valuesperhour>
<valueproducer type=″LINEAR″>
<initvalue>10</initvalue>
<finalvalue>15</finalvalue>
<noisepercent>10</noisepercent>
</valueproducer>
</rule>
<rule>
<day>*</day>
<hour>18-21</hour>
<valuesperhour>2</valuesperhour>
<valueproducer type=″RANDOM″>
<minvalue>30</minvalue>
<maxvalue>40</maxvalue>
<noisepercent>0</noisepercent>
</valueproducer>
</rule>
<rule>
<day>4</day>
<hour>12-14</hour>
<valuesperhour>2</valuesperhour>
<valueproducer type=″LINEAR″>
<initvalue>60</initvalue>
<initslope>0</initslope>
<noisepercent>0</noisepercent>
</valueproducer>
</rule>
</rules>
</metric>

Configuration files containing rule definitions may be stored as models associated with particular network elements or types of network elements in the database 120 (FIG. 1).

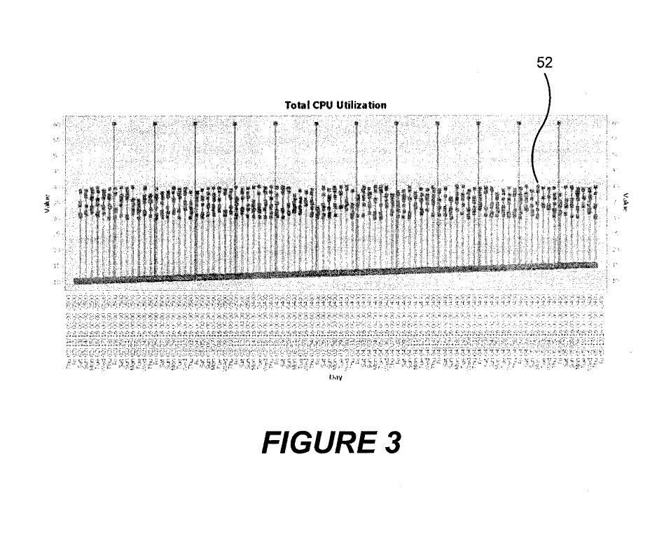

FIG. 3 illustrates an example event data output in graphical form of events 52 generated by an event generator 180 using the metric definition shown in Table 3. In FIG. 3, the x-axis corresponds to time, and the y-axis corresponds to CPU utilization, expressed as a percentage. As can be seen in FIG. 3, the CPU utilization generally increases in a linear fashion over the course of the simulation except for random spikes every day between 6 PM and 9 PM, and large spikes every Thursday from noon to 2 PM.

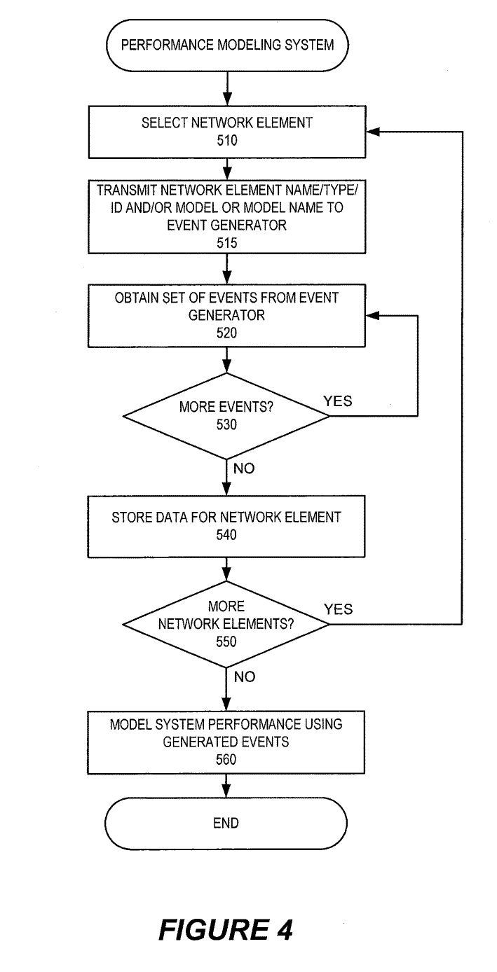

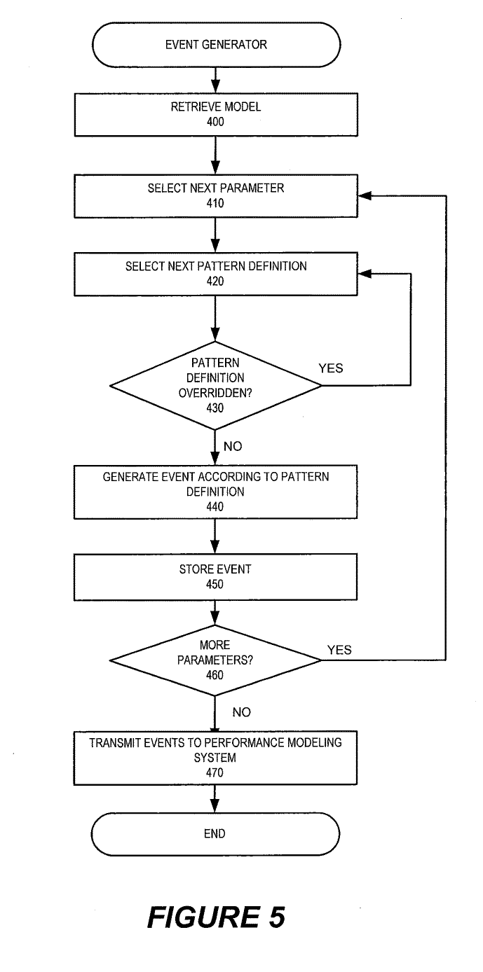

FIGS. 4 and 5 are flowcharts of operations that may be performed according to various embodiments described herein. In particular, FIG. 4 illustrates operations of an performance modeling system 100 according to some embodiments for obtaining simulated events for a plurality of network elements in an IT system. FIG. 5 illustrates operations of an event generator 180 according to some embodiments for generating simulated events for a plurality of parameters of a network element.

Referring to FIG. 4, the operations include selecting a network element in the IT system from the system model 145 (block 510). The performance modeling system 100 may iterate through a list of network elements in the IT system to generate simulation data for one network element, every network element, or a subset of network elements in the IT system, depending on the needs of the performance modeling system.

The performance modeling system 100 may then transmit a name/ID/type of network element to the event generator 180. Alternatively or additionally, the performance modeling system 100 may transmit a model or a model name to the event generator 180 for use in generating the events (block 515).

For each network element, the performance modeling system 100 then requests the event generator 180 to generate a set of events (block 520) as needed for simulation. For example, the performance modeling system 100 may send a model or model name associated with a CPU to the event generator 180 and request the event generator 180 to generate events in accordance with the model for a first period of time. The event generator 180 generates the requested events and provides them to the performance modeling system 100 in accordance with the methods described herein.

The performance modeling system 100 then checks at block 530 to see if more events are needed, such as events for a second period of time, and if more events are needed, operations return to block 520 where the performance modeling system 100 obtains a further set of events associated with the selected network element from the event generator 180.

If there are no more events needed for the selected network element, operations proceed to block 540, where the performance modeling system 100 stores the event data for the selected network element. The performance modeling system 100 then checks at block 550 to see if there are more network elements for which events need to be generated. If so, operations return to block 510, and the performance modeling system 100 selects the next network element from the system model 145.

If event data has been obtained for all network elements, operations proceed to block 560, where the performance modeling system 100 models performance of the IT system using the generated events. In some embodiments, the performance modeling system 100 models performance of the IT system using both the generated events and real events derived from a system under test 200 (FIG. 1).

Operations of an event generator 180 according to some embodiments are illustrated in FIG. 5. As shown therein, for a given network element for which event data is desired, the event generator 180 first receives a model associated with the network element (block 400). The model may be received from the performance modeling system 100 or may be retrieved from the database 120. The event generator 180 then selects from the model a parameter associated with the network element (block 410). For example, for a CPU, the selected parameter may be CPU utilization, cache utilization, etc. For a data store, the selected parameter may be data rate, buffer utilization, etc.

For the selected parameter, the event generator 180 selects a next pattern definition from the hierarchy of pattern definitions associated with the parameter (block 420). Based on the simulation time, the event generator 180 then checks the hierarchy of pattern definitions to determine if the selected pattern definition has been overridden (block 430). If so, the event generator 180 repeats the selection of a next pattern definition from the hierarchy of pattern definitions until a pattern definition that has not been overridden is found.

Once a pattern definition that has not been overridden has been selected, the event generator 180 generates an event according to the selected pattern definition (block 440). The event generator 180 stores the event at block 450, and then checks to see if there are any further parameters that need to be simulated for the selected network element in block 460. if so, operations return to block 410 and the next parameter is selected. If not, then at block 470 the generated events are then transmitted to the performance modeling system.

It will be appreciated that many different implementations are possible within the scope of the inventive concepts. For example, although illustrated as separate entities, the event generator 180 may be implemented within the performance modeling system 100, such as in the form of a functional module within the performance modeling system 100. Moreover, many of the elements and functions illustrated as belonging to the event generator 180 and the performance modeling system 100 may be implemented in other ways. For example, the discrete event models 130 could be stored within the performance modeling system 100, and/or the system model 145 could be provided to the event generator 180. In some embodiments, the event generator 180 may store all events associated with a particular network element and transmit them together to the performance modeling system 100, while in other embodiments the event generator may transmit the events to the performance modeling system 100 as they are generated.

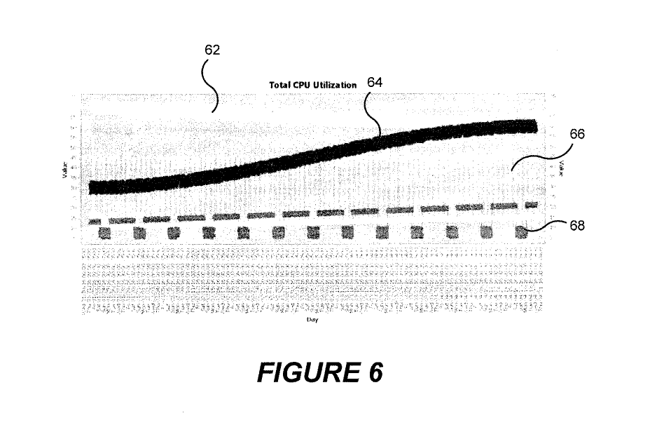

FIG. 6 illustrates event data generated for different servers in an IT system in accordance with various embodiments described herein. For example, events 62 represent a server with CPU utilization declining with some degree of randomness. Events 64 represent a server with CPU utilization increasing with a saturation trend. Events 66 represent a server with CPU utilization increasing with different behavior on certain week days and hours. Events 68 represent a server with CPU utilization increasing with different behavior on weekends. As can be seen in FIG. 6, simulated event data with a wide range of characteristics can be easily generated in accordance with various embodiments described herein to provide complicated data sets for testing a system model in a desired manner.

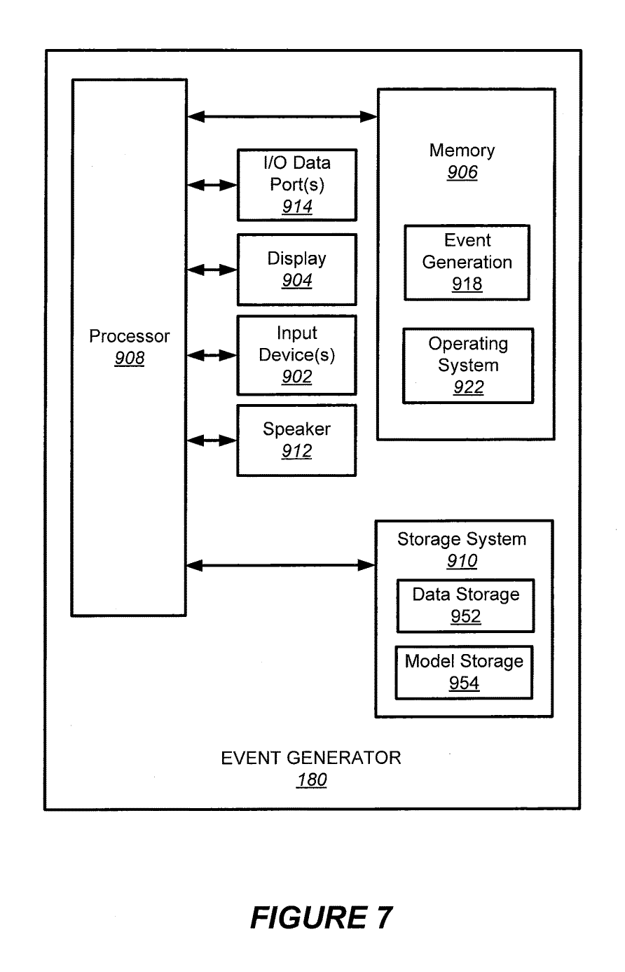

FIG. 7 is a block diagram of an event generator 180 that is configured according to various embodiments described herein. The event generator 180 may implement the operations illustrated in FIG. 5. The event generator 180 includes a processor 908 that communicates with a memory 906, a storage system 910, and one or more I/O data ports 914. The event generator 180 may also include a display 904, an input device 902 and a speaker 912. The memory 906 stores program instructions and/or data that configure the event generator 180 for operation. In particular, the memory 906 may store an event generation module 918 and an operating system module 922.

The storage system 910 may include, for example, a hard disk drive or a solid state drive, and may a data storage 952 for storing generated events and a model storage 954 for storing the event models.

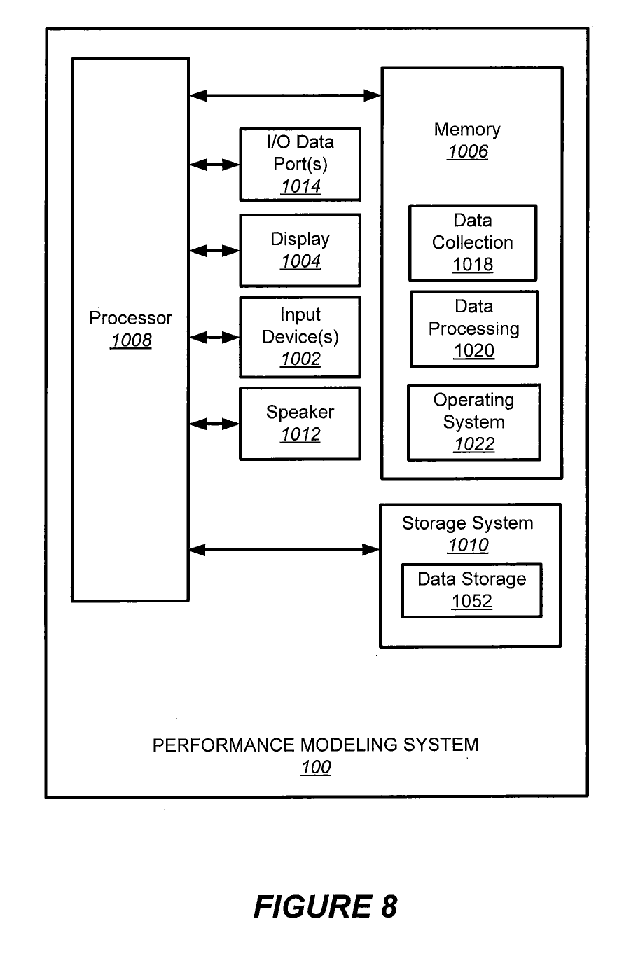

FIG. 8 is a block diagram of a performance modeling system 100 that is configured according to various embodiments described herein. The performance modeling system 100 may implement the operations illustrated in FIG. 4. The performance modeling system 100 includes a processor 1008 that communicates with a memory 1006, a storage system 1010, and one or more I/O data ports 1014. The event generator 180 may also include a display 1004, an input device 1002 and a speaker 1012. The memory 1006 stores program instructions and/or data that configure the performance modeling system 100 for operation. In particular, the memory 1006 may store a data collection module 1018, a data processing module 1020 and an operating system module 1022.

The storage system 1010 may include, for example, a hard disk drive or a solid state drive, and may a data storage 1052 for storing events received from the event generator 180.

### FURTHER DEFINITIONS AND EMBODIMENTS

In the above-description of various embodiments, various aspects may be illustrated and described herein in any of a number of patentable classes or contexts including any new and useful process, machine, manufacture, or composition of matter, or any new and useful improvement thereof Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product comprising one or more computer readable media having computer readable program code embodied thereon.

Any combination of one or more computer readable media may be used. The computer readable media may be a computer readable signal medium or a non-transitory computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible non-transitory medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

, Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a non-transitory computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

The description herein has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed:

1. A method, comprising:
providing a hierarchy of pattern definitions, wherein each pattern definition in the hierarchy of pattern definitions is associated with a parameter that is used to simulate operation of a computer system, and wherein each pattern definition in the hierarchy of pattern definitions comprises at least a value producer and a time interval;
traversing the hierarchy of pattern definitions for each parameter, wherein traversing the hierarchy of pattern definitions comprises repeating, until a final pattern definition is selected, steps of:
(a) retrieving a first pattern definition;
(b) determining if a simulation time falls within the time interval associated with the first pattern definition;
(c) in response to determining that the simulation time falls within the time interval associated with the first pattern definition, determining if the first pattern definition is overridden by a subsequent pattern definition in the hierarchy of pattern definitions;
(d) in response to determining that the first pattern definition is overridden by a subsequent pattern definition, retrieving the subsequent pattern definition; and
(e) in response to determining that the first pattern definition is not overridden by a subsequent pattern definition, selecting the first pattern definition as the final pattern definition; and
generating an event associated with the parameter in accordance with the value generator of the selected pattern definition; and
transmitting the event to a system testing platform.

2. The method of claim 1, further comprising:
sequentially selecting a system element from a plurality of system elements in the computer system;
and generating events related to the selected system element.

3. The method of claim 1, further comprising generating a plurality of events associated with the parameter in accordance with the value generator, and transmitting the plurality of events to the system testing platform.

4. The method of claim 1, wherein the hierarchy of pattern definitions for a given parameter comprises a list of pattern definitions arranged in hierarchical order, and wherein traversing the hierarchy of pattern definitions comprises processing the list sequentially until a pattern definition is found that is not overridden by a subsequent pattern definition.

5. The method of claim 1, wherein the value producer defines a type of value produced and a range of value produced.

6. The method of claim 5, wherein the value producer comprises one of a linear deterministic value producer and a nonlinear deterministic value producer.

7. The method of claim 5, wherein the value producer comprises a random value producer and a deterministic value producer, wherein the value is produced as a sum of the output of the random value producer and the deterministic value producer.

8. The method of claim 5, wherein the value producer comprises a random value producer.

9. An event generator, comprising:
a processor;
a memory coupled to the processor; and
a discrete event generation module in the memory, the discrete event generation module configured, when executed by the processor, to generate simulated events related to operation of a computer system using a hierarchy of pattern definitions, wherein each pattern definition in the hierarchy of pattern definitions is associated with a parameter that is used to simulate operation of a computer system, and wherein each pattern definition in the hierarchy of pattern definitions comprises at least a value producer and a time interval;
wherein the discrete event simulation module is configured to traverse the hierarchy of pattern definitions for each parameter, wherein traversing the hierarchy of pattern definitions comprises repeating, until a final pattern definition is selected, steps of:
(a) retrieving a first pattern definition;
(b) determining if a simulation time falls within the time interval associated with the first pattern definition;
(c) in response to determining that the simulation time falls within the time interval associated with the first pattern definition, determining if the first pattern definition is overridden by a subsequent pattern definition in the hierarchy of pattern definitions;
(d) in response to determining that the first pattern definition is overridden by a subsequent pattern definition, retrieving the subsequent pattern definition; and
(e) in response to determining that the first pattern definition is not overridden by a subsequent pattern definition, selecting the first pattern definition as the final pattern definition; and
wherein the discrete event simulation module is configured to generate an event associated with the parameter in accordance with the value generator of the selected pattern definition, and to transmit the event to a system testing platform.

10. The event generator of claim 9, wherein the discrete event simulation module is further configured to sequentially select a system element from a plurality of system elements in the computer system, and generate events related to the selected system element.

11. The event generator of claim 9, further comprising generating a plurality of events associated with the parameter in accordance with the value generator, and transmitting the plurality of events to the system testing platform.

12. The event generator of claim 9, wherein the hierarchy of pattern definitions for a given parameter comprises a list of pattern definitions arranged in hierarchical order, and wherein traversing the hierarchy of pattern definitions comprises processing the list sequentially until a pattern definition is found that is not overridden by a subsequent pattern definition.

13. The event generator of claim 9, wherein the value producer defines a type of value produced and a range of value produced.

14. The event generator of claim 13, wherein the value producer comprises one of a linear deterministic value producer and a nonlinear deterministic value producer.

15. The event generator of claim 13, wherein the value producer comprises a random value producer and a deterministic value producer, wherein the value is produced as a sum of the output of the random value producer and the deterministic value producer.

16. The event generator of claim 13, wherein the value producer comprises a random value producer.

17. A computer program product, comprising:
a non-transitory computer readable storage medium storing program code executable by a processor of an event generator to perform operations comprising:
providing a hierarchy of pattern definitions, wherein each pattern definition in the hierarchy of pattern definitions is associated with a parameter that is used to simulate operation of a computer system, and wherein each pattern definition in the hierarchy of pattern definitions comprises at least a value producer and a time interval;
traversing the hierarchy of pattern definitions for each parameter, wherein traversing the hierarchy of pattern definitions comprises repeating, until a final pattern definition is selected, steps of:
(a) retrieving a first pattern definition;
(b) determining if a simulation time falls within the time interval associated with the first pattern definition;
(c) in response to determining that the simulation time falls within the time interval associated with the first pattern definition, determining if the first pattern definition is overridden by a subsequent pattern definition in the hierarchy of pattern definitions;
(d) in response to determining that the first pattern definition is overridden by a subsequent pattern definition, retrieving the subsequent pattern definition; and
(e) in response to determining that the first pattern definition is not overridden by a subsequent pattern definition, selecting the first pattern definition as the final pattern definition; and
generating an event associated with the parameter in accordance with the value generator of the selected pattern definition; and
transmitting the event to a system testing platform.

18. The computer program product of claim 17, the operations further comprising sequentially selecting a system element from a plurality of system elements in the computer system, and generating events related to the selected system element.

19. The computer program product of claim 17, wherein the hierarchy of pattern definitions for a given parameter comprises a list of pattern definitions arranged in hierarchical order, and wherein traversing the hierarchy of pattern definitions comprises processing the list sequentially until a pattern definition is found that is not overridden by a subsequent pattern definition.

20. The computer program product of claim 17, wherein the value producer defines a type of value produced and a range of value produced.
